(19) United States
(12) Patent Application Publication
(10) Pub. No.: US 2016/0047126 A1
(43) Pub. Date: Feb. 18, 2016

(54) WATERPROOF MAT FOR AN ARCHITECTURE

(71) Applicant: YI-MIN CHEN, Kaohsiung City (TW)

(72) Inventor: YI-MIN CHEN, Kaohsiung City (TW)

(21) Appl. No.: 14/460,613

(22) Filed: Aug. 15, 2014

(51) Int. Cl. E04D 5/02; B32B 5/26; D06N 5/00; B32B 3/26; B32B 7/12; B32B 5/02; B32B 3/30

(52) U.S. Cl. CPC E04D 5/02; B32B 5/024; B32B 5/26; B32B 3/30; B32B 3/263; B32B 7/12; D06N 5/00; B32B 2255/02; B32B 2262/0253; B32B 2307/7265; B32B 2307/712; B32B 2419/06; D10B 2321/021; D10B 2321/022

(57) ABSTRACT

A waterproof mat for an architecture includes a surface on which a plurality of grooves or ridges extending in a warp direction and a plurality of grooves or ridges extending in a weft direction are formed. The grooves or ridges extending in the warp direction and the grooves or ridges extending in the weft direction cross each other. A plurality of ribs is formed on the surface and extends in the warp direction. The ribs are spaced from each other. A height of the ribs is larger than an average depth or an average height of the grooves or ridges extending in the warp and weft directions. A width of the ribs is larger than an average width of the grooves or ridges extending in the warp and weft directions.

### BACKGROUND OF THE INVENTION

The present invention relates to an architectural material and, more particularly, to a waterproof mat for an architecture.

Waterproof construction is generally required for an architecture, particularly a wooden building, wherein a waterproof mat is generally mounted in a thickness of a basic building material of a rooftop or a wall. Such a waterproof mat is generally made of, but not limited to, a PE/PP laminated fabric treated with waterproof processing.

Since buildings often include a slant rooftop, an architectural worker could slip while working on the slant rooftop for mounting a waterproof mat. The architectural worker could be injured or even got killed by the slip. Although some of waterproof mats are made of woven cloth which provides a level difference through actual warp/weft crossing by weaving, creating a rough, anti-slipping surface. In another approach, the surface of the waterproof mat is rolled to form a warp/weft crossing pattern to create the level difference, creating the desired rough, anti-slipping surface. However, the roughnesses of the surfaces of waterproof mats made of woven cloth to present the level difference or rolled to present the level difference are still insufficient.

Thus, a need exists for a novel a waterproof mat for an architecture.

### BRIEF SUMMARY OF THE INVENTION

A waterproof mat for an architecture according to the present invention includes a surface on which a plurality of grooves or ridges extending in a warp direction and a plurality of grooves or ridges extending in a weft direction are formed. The plurality of grooves or ridges extending in the warp direction and the plurality of grooves or ridges extending in the weft direction cross each other. A plurality of ribs is formed on the surface and extends in the warp direction. The plurality of ribs is spaced from each other. The plurality of ribs includes a height larger than an average depth or an average height of the plurality of grooves or ridges extending in the warp direction and the plurality of grooves or ridges extending in the weft direction. The plurality of ribs includes a width larger than an average width of the plurality of grooves or ridges extending in the warp direction and the plurality of grooves or ridges extending in the weft direction.

Specifically, a rough, anti-slipping surface is created by the level difference formed by the ridges extending in the warp direction and the ridges extending in the weft direction and crossing the ridges. Furthermore, ribs are formed on the surface of the waterproof mat and are spaced from each other. Furthermore, the height of the ribs is larger than the average height of the ridges extending in the warp and weft directions. The width of the ribs is larger than the average width of the ridges extending in the warp and weft directions.

In an embodiment, the waterproof mat includes a substrate providing a surface with a roughness and an anti-slipping effect through actual warp/weft crossing by weaving or through a warp/weft crossing pattern formed by rolling. The waterproof mat further includes a waterproof coating mounted to a side of the substrate and tightly bonded to the substrate. The waterproof coating includes a surface having a level difference and a roughness corresponding to a level difference and the roughness provided by the actual warp/weft crossing or the warp/weft crossing pattern.

The shoes and clothes of workers on the rooftop have different frictional characteristics. People have different skin roughnesses. The waterproof mat according to the present invention provides a composite roughness effect (a large roughness containing a small roughness) such that the waterproof mat can be used in different frictional situations while achieving a sufficient anti-slipping effect, enhancing safety of the worker.

By providing spaced ribs extending in the warp direction on the surface of the waterproof mat, a channel is defined between two adjacent ribs. Thus, either the waterproof mat is used on the rooftop or in a wall, when leakage occurs, water can be guided by the channels to avoid accumulation of water.

The present invention will become clearer in light of the following detailed description of illustrative embodiments of this invention described in connection with the drawings.

### DESCRIPTION OF THE DRAWINGS

FIG. 1 is a perspective view of a waterproof mat for an architecture according to the present invention.

FIG. 1A is an enlarged view of a circled portion of FIG. 1.

FIG. 2 is a top view of the waterproof mat of FIG. 1.

FIG. 3 is a perspective view of a building using the waterproof mats according to the present invention.

FIG. 3A is an enlarged view of a circled portion of FIG. 3.

FIG. 3B is an enlarged view of another circled portion of FIG. 3.

FIG. 4 is a cross sectional view of an example of the waterproof mat according to the present invention.

FIG. 5 is a cross sectional view of another example of the waterproof mat according to the present invention.

### DETAILED DESCRIPTION OF THE INVENTION

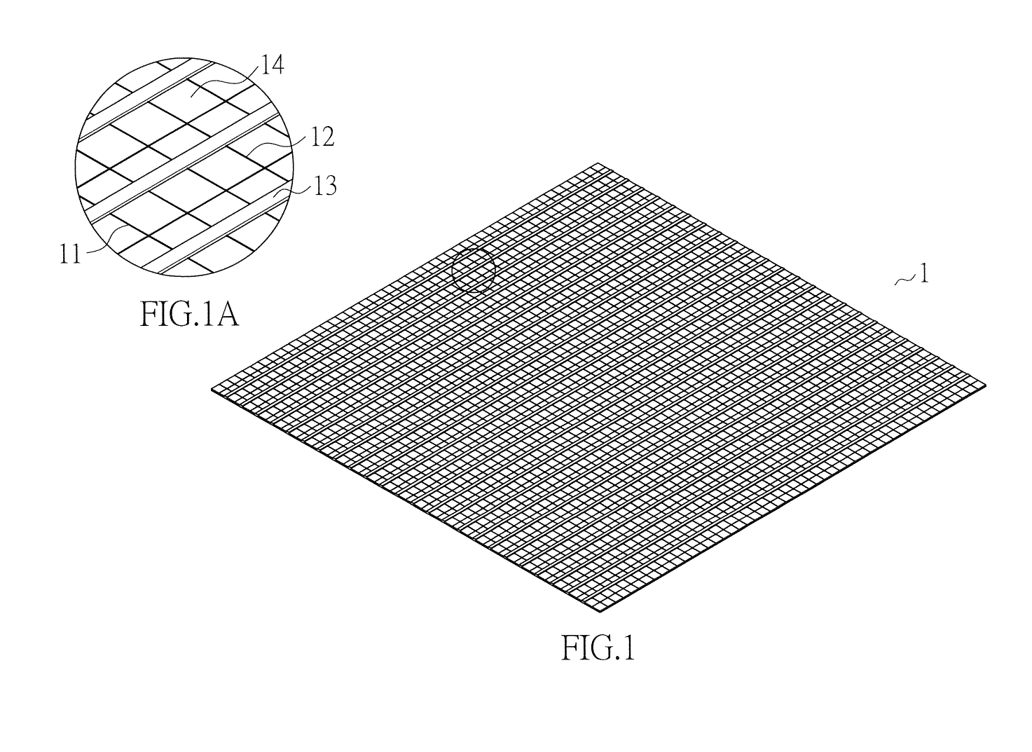

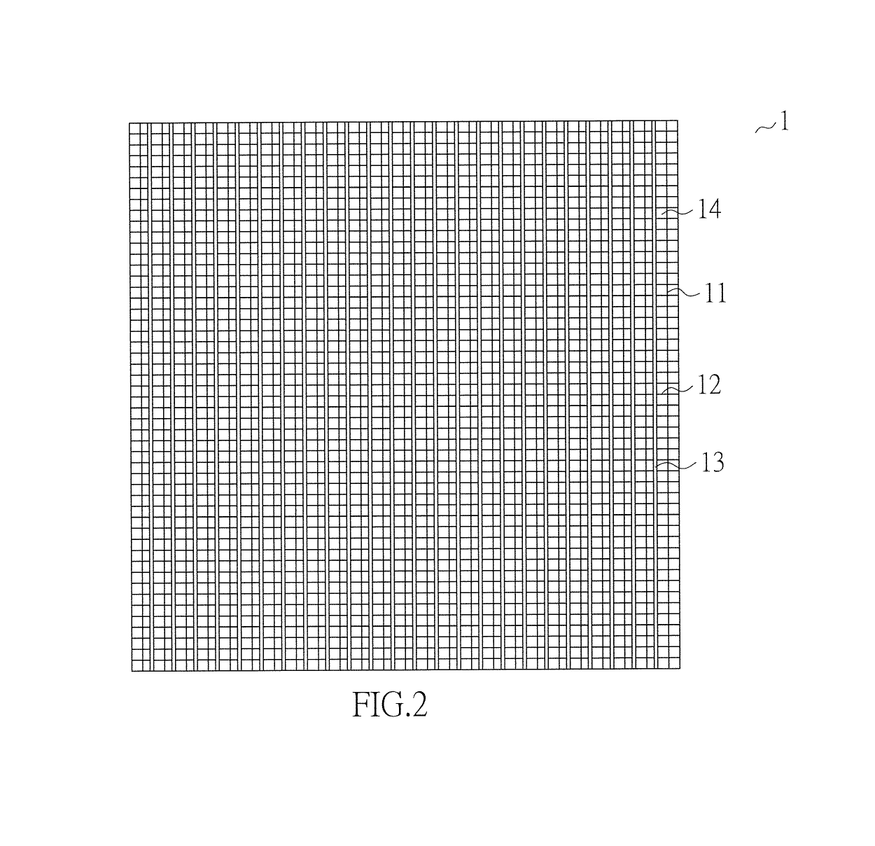

With reference to FIGS. 1, 1A, and 2, a waterproof mat 1 for an architecture according to the present invention includes a surface on which a plurality of ridges (or grooves) 11 extending in a warp direction and a plurality of ridges (or grooves) 12 extending in a weft direction are formed. The ridges 11 extending in the warp direction and the ridges 12 extending in the weft direction cross each other, creating a level difference and, thus, providing an anti-slipping effect.

The waterproof mat 1 further includes a plurality of ribs 13 formed on the surface and extending in the warp direction. The ribs 13 are spaced from each other. The ribs 13 include a height larger than an average height of the ridges 11, 12 (an average depth in the case of grooves) extending in the warp and weft directions. The ribs 13 include a width larger than an average width of the ridges 11, 12 extending in the warp and weft directions.

The waterproof mat 1 further includes a plurality of ribs 13 formed on the surface and extending in the warp direction. The ribs 13 are spaced from each other. The ribs 13 include a height larger than an average height of the ridges 11, 12 (an average depth in the case of grooves) extending in the warp and weft directions. The ribs 13 include a width larger than an average width of the ridges 11, 12 extending in the warp and weft directions.

Specifically, a rough, anti-slipping surface is created by the level difference formed by the ridges 11 extending in the warp direction and the ridges 12 extending in the weft direction and crossing the ridges 11. Furthermore, ribs 13 are formed on the surface of the waterproof mat 1 and are spaced from each other. Furthermore, the height of the ribs 13 is larger than the average height of the ridges 11, 12 extending in the warp and weft directions. The width of the ribs is larger than the average width of the ridges 11, 12 extending in the warp and weft directions.

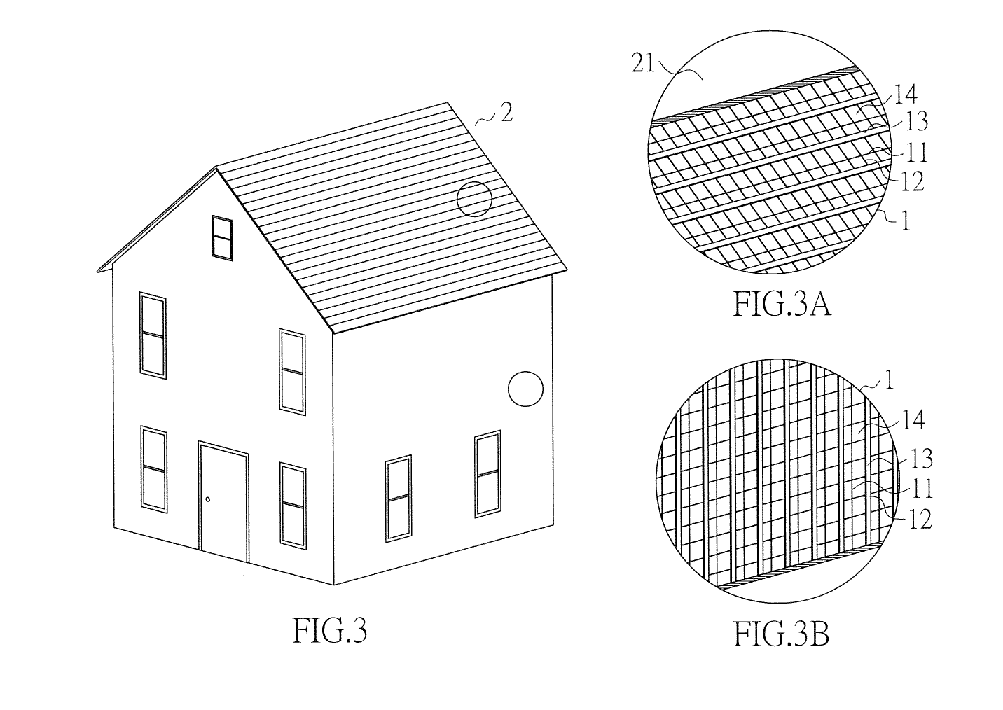

FIG. 3 shows a building with aslant rooftop 2 on which the waterproof mat 1 is mounted. As can be seen from FIG. 3A, the waterproof mat 1 is covered by a covering layer 21. The shoes and clothes of workers on the rooftop 2 have different frictional characteristics. People have different skin roughnesses. The waterproof mat 1 according to the present invention provides a composite roughness effect (a large roughness containing a small roughness) such that the waterproof mat 1 can be used in different frictional situations while achieving a sufficient anti-slipping effect, enhancing safety of the worker.

With reference to FIGS. 3 and 3B, the waterproof mat 1 can also be used as an intermediate layer in a wall. By providing spaced ribs 13 extending in the warp direction on the surface of the waterproof mat 1, a channel 14 is defined between two adjacent ribs 13. Thus, either the waterproof mat 1 is used on the rooftop 1 or in a wall, when leakage occurs, water can be guided by the channels 14 to avoid accumulation of water.

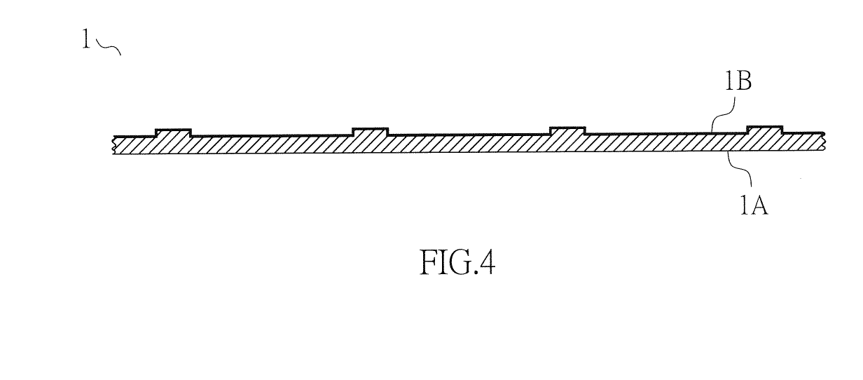

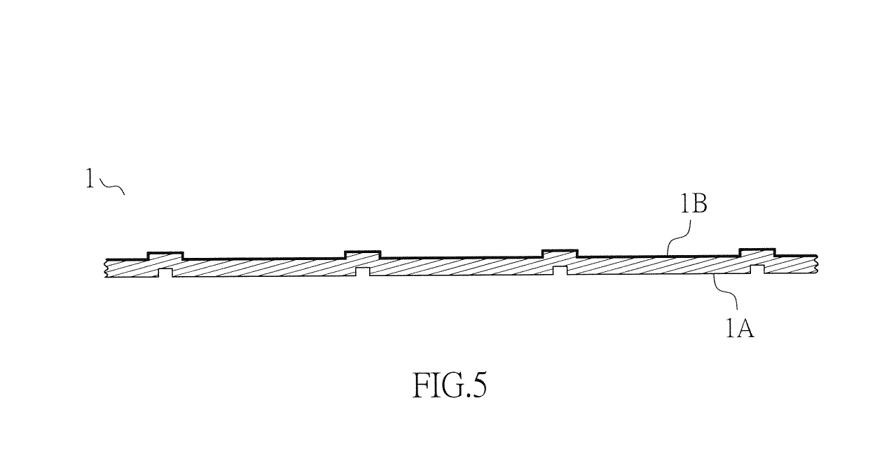

FIGS. 4 and 5 show two examples of the waterproof mat 1. The waterproof mat 1 can include a substrate 1A made of polypropylene (PP), polyethylene (PE), or a mixture of PP and PE. The substrate 1A provides a surface with a roughness and an anti-slipping effect through actual warp/weft crossing by weaving or through a warp/weft crossing pattern formed by rolling.

The waterproof mat 1 further includes a waterproof coating 1B made of polypropylene (PP), polyethylene (PE), or a mixture of PP and PE. The waterproof coating B is mounted to a side of the substrate 1A and tightly bonded to the substrate 1A. The waterproof coating 1B includes a surface having a level difference and a roughness corresponding to a level difference and the roughness provided by the actual warp/weft crossing or the warp/weft crossing pattern. The waterproof effect is enhanced by the composite structure.

In the example shown in FIG. 4, the bottom side of the substrate 1A is flat. In the example shown in FIG. 5, the bottom side of the substrate 1A includes recessions to provide a level difference corresponding to the surface of the substrate 1A.

Although specific embodiments have been illustrated and described, numerous modifications and variations are still possible without departing from the scope of the invention. The scope of the invention is limited by the accompanying claims.

1. A waterproof mat for an architecture comprising:
a surface on which a plurality of grooves or ridges extending in a warp direction and a plurality of grooves or ridges extending in a weft direction are formed, with the plurality of grooves or ridges extending in the warp direction and the plurality of grooves or ridges extending in the weft direction crossing each other; and
a plurality of ribs formed on the surface and extending in the warp direction, with the plurality of ribs spaced from each other, with the plurality of ribs including a height larger than an average depth or an average height of the plurality of grooves or ridges extending in the warp direction and the plurality of grooves or ridges extending in the weft direction, and with the plurality of ribs including a width larger than an average width of the plurality of grooves or ridges extending in the warp direction and the plurality of grooves or ridges extending in the weft direction.

2. The waterproof mat for an architecture as claimed in claim 1, with the waterproof mat including a substrate, with the substrate providing a surface with a roughness and an anti-slipping effect through actual warp/weft crossing by weaving or through a warp/weft crossing pattern formed by rolling, with the waterproof mat further including a waterproof coating mounted to a side of the substrate and tightly bonded to the substrate, and with the waterproof coating including a surface having a level difference and a roughness corresponding to a level difference and a roughness provided by the actual warp/weft crossing or the warp/weft crossing pattern.
